(19) United States
(12) Patent Application Publication
(10) Pub. No.: US 2023/0410344 A1
(43) Pub. Date: Dec. 21, 2023

(54) DETECTION OF SCALE BASED ON IMAGE DATA AND POSITION/ORIENTATION DATA

(71) Applicant: GOOGLE LLC, Mountain View, CA (US)

(72) Inventors: Eric Turner, Somerville, MA (US); Idris Syed Aleem, Kitchener (CA); Sushant Umesh Kulkarni, Waterloo (CA); Rees Anwyl Samuel Simmons, Waterloo (CA); Ryan Christopher DuToit, Redwood City, CA (US)

(21) Appl. No.: 17/807,041

(22) Filed: Jun. 15, 2022

(51) Int. Cl. G06T 7/60; G06T 7/73

(52) U.S. Cl. CPC G06T 7/60; G06T 2207/30201; G06T 7/74

(57) ABSTRACT

A system and method of detecting scale from image data obtained by a computing device together with position and orientation of the computing device is provided. The scale may be used for the virtual selection and/or fitting of a wearable device such as a head mounted wearable device and other such wearable devices. The system and method may include capturing a series of frames of image data, and detecting one or more fixed features in the series of frames of image data. Position and orientation data associated with the capture of the image data is combined with the position data related to the one or more fixed features to set a scale that is applicable to the image data. Scale may be determined without the use of a reference object having known scale, specialized equipment, and the like.

### TECHNICAL FIELD

This relates in general to the detection of scale from image data, and in particular to the detection of scale from image data collected by a front facing camera of a mobile device using combined with position and/or orientation data provided by position and/or orientation sensors of the mobile device.

### BACKGROUND

A manner in which the wearable device fits a particular wearer may be dependent on features specific to the wearer and how the wearable device interacts with the features associated with the specific body part at which the wearable device is worn by the wearer. A wearer may want to customize a wearable device for fit and/or function. For example, when fitting a pair of glasses, the wearer may want to customize the glasses to incorporate selected frame(s), prescription/corrective lenses, a display device, computing capabilities, and other such features. Many existing systems for procurement of these types of wearable devices do not provide for accurate fitting and customization without access to a retail establishment and/or specialized equipment. Existing virtual systems may provide a virtual try-on capability, but may lack the ability to accurately detect scale from images of the wearer without specialized equipment.

### SUMMARY

In a first general aspect A computer-implemented method may include capturing first image data, via an application executing on a computing device operated by a user, the first image data including a head of the user; detecting at least one fixed feature in the first image data; capturing second image data, the second image data including the head of the user; detecting the at least one fixed feature in the second image data; detecting a change in a position and an orientation of the computing device, from a first position and a first orientation corresponding to the capturing of the first image data, to a second position and a second orientation corresponding to the capturing of the second image data; detecting a change in a position of the at least one fixed feature between the first image data and the second image data; correlating the change in the position and the orientation of the computing device with the change in the position of the at least one fixed feature; and determining a scale value applicable to the first image data and the second image data based on the correlating.

In some implementations, the at least one fixed feature includes at least one facial feature. In some examples, the at least one facial feature includes at least one of: a distance between an outer corner portion of a right eye and an outer corner portion of a left eye of the user; a distance between an inner corner portion of a right eye and an inner corner portion of a left eye of the user; or a distance between a pupil of a right eye and a pupil of a right eye of the user.

In some implementations, the at least one fixed feature includes a fixed element detected in a background area surrounding the head of the user. In some implementations, the at least one fixed feature includes a plurality of fixed features, including at least one facial landmark defined by two fixed facial features; and at least one fixed element defined by at least two fixed key points detected in a background area surrounding the head of the user. In some implementations, detecting the change in the position and the orientation of the computing device includes detecting the first position and the first orientation of the computing device in response to receiving first data provided by an inertial measurement unit of the computing device at the capturing of the first image data; detecting the second position and the second orientation of the computing device in response to receiving second data provided by the inertial measurement unit of the computing device at the capturing of the second image data; and determining a magnitude of movement of the computing device corresponding to the change in the position and the orientation of the computing device based on a comparison of the second data to the first data. In some examples, correlating the change in the position and the orientation of the computing device with the change in the position of the at least one fixed feature includes associating the magnitude of the movement of the computing device to the change in the position of the at least one fixed feature; and assigning a scale value based on the associating.

In some implementations, capturing the first image data and capturing the second image data includes initiating operation of a front facing camera of the computing device; and capturing, by the front facing camera, the first image data and the second image data as the computing device is moved relative to the head of the user. In some implementations, the method also includes repeatedly capturing the first image data and the second image data as the computing device is moved relative to the user to capture image data from a plurality of different positions and orientations of the computing device relative to the head of the user; correlating a plurality of changes in position and orientation of the computing device with a corresponding plurality of changes in position of the at least one fixed feature; determining a plurality of estimated scale values based on the correlating; and aggregating the plurality of estimated scale values to determine the scale value for sizing of a wearable device based on image data captured by the computing device.

In some implementations, the capturing first image data and the capturing the second image data includes sequentially capturing a first image and a second image. In some examples, the capturing the first image data and the capturing the second image data includes capturing additional image data between the capturing of the first image data and the second image data.

In another general aspect, a non-transitory computer-readable medium may store executable instructions that when executed by at least one processor of a computing device are configured to cause the at least one processor to capture, by an image sensor of the computing device, first image data, the first image data including a head of a user; detect at least one fixed feature in the first image data; capture, by the image sensor, second image data, the second image data including the head of the user; detect the at least one fixed feature in the second image data; detect a change in a position and an orientation of the computing device, from a first position and a first orientation corresponding to the capture of the first image data, to a second position and a second orientation corresponding to the capture of the second image data; detect a change in a position of the at least one fixed feature between the first image data and the second image data; correlate the change in the position and the orientation of the computing device with the change in the position of the at least one fixed feature; and determine a scale value applicable to the first image data and the second image data based on the correlation.

In some examples, the at least one fixed feature includes at least one facial feature. The at least one facial feature may include at least one of a distance between an outer corner portion of a right eye and an outer corner portion of a left eye of the user; a distance between an inner corner portion of a right eye and an inner corner portion of a left eye of the user; or a distance between a pupil of a right eye and a pupil of a right eye of the user. The at least one fixed feature may include a fixed element detected in a background area surrounding the head of the user. In some examples, the fixed feature includes a plurality of fixed features, including at least one facial landmark defined by two fixed facial features; and at least one fixed element defined by at least two fixed key points detected in a background area surrounding the head of the user.

In some examples, the instructions cause the at least one processor to detect the first position and the first orientation of the computing device in response to receiving first data provided by an inertial measurement unit of the computing device at the capturing of the first image data; detect the second position and the second orientation of the computing device in response to receiving second data provided by the inertial measurement unit of the computing device at the capturing of the second image data; and determine a magnitude of movement of the computing device corresponding to the change in the position and the orientation of the computing device based on a comparison of the second data to the first data.

In some examples, the instructions cause the at least one processor to: associate the magnitude of the movement of the computing device to the change in the position of the at least one fixed feature; and assign a scale value based on the association of the magnitude of the movement of the computing device with the change in the position of the at least one fixed feature.

In some examples, the instructions cause the at least one processor to initiate operation of a front facing camera of the computing device; and capture, by the front facing camera, the first image data and the second image data as the computing device is moved relative to the head of the user. In some examples, the instructions may cause the at least one processor to repeatedly capture the first image data and the second image data as the computing device is moved relative to the user to capture image data from a plurality of different positions and orientations of the computing device relative to the head of the user; correlate a plurality of changes in position and orientation of the computing device with a corresponding plurality of changes in position of the at least one fixed feature; determine a plurality of estimated scale values based on the correlating; and aggregate the plurality of estimated scale values to determine the scale value for sizing of a wearable device based on image data captured by the computing device. In some examples, the instructions cause the at least one processor to at least one of capture the first image data and the second image data sequentially; or capture additional image data between the capture of the first image data and the second image data.

In another general aspect, a system may include a computing device, including: an image sensor; at least one processor; and a memory storing instructions. When executed by the at least one processor, the instructions may cause the at least one processor to capture first image data, the first image data including a head of a user; detect at least one fixed feature in the first image data; capture second image data, the second image data including the head of the user; detect the at least one fixed feature in the second image data; detect a change in a position and an orientation of the computing device, from a first position and a first orientation corresponding to the capturing of the first image data, to a second position and a second orientation corresponding to the capturing of the second image data; detect a change in a position of the at least one fixed feature between the first image data and the second image data; correlate the change in the position and the orientation of the computing device with the change in the position of the at least one fixed feature; and determine a scale value applicable to the first image data and the second image data based on the correlating.

In some implementations, the at least one fixed feature includes a plurality of fixed features, including at least one facial landmark defined by at least two fixed facial features; and at least one fixed element defined by at least two fixed key points detected in a background area surrounding the head of the user.

The details of one or more implementations are set forth in the accompanying drawings and the description below. Other features will be apparent from the description and drawings, and from the claims.

### BRIEF DESCRIPTION OF THE DRAWINGS

FIG. 1 illustrates an example system, in accordance with implementations described herein.

FIG. 2A is a front view, and FIG. 2B is a rear view, of an example wearable device shown in FIG. 1, in accordance with implementations described herein.

FIG. 2C is a front view of an example handheld computing device shown in FIG. 1, in accordance with implementations described herein.

FIG. 3 is a block diagram of a system, in accordance with implementations described herein.

FIG. 4A illustrates an example computing device in an image capture mode.

FIG. 4B illustrates an example display portion of the example computing device shown in FIG. 4A.

FIGS. 5A-5F illustrate an example process for capturing image data using an example computing device.

FIG. 6 is a flowchart of an example method, in accordance with implementations described herein.

FIG. 7 illustrates example computing devices of the computing systems discussed herein.

### DETAILED DESCRIPTION

This disclosure relates to systems and methods for determining scale from image data captured by an image sensor of a computing device. Systems and methods, in accordance with implementations described herein, provide for the determination of scale from images captured by the image sensor of the computing device without the use of a reference object in the images to provide a known scale. Systems and methods, in accordance with implementations described herein, provide for the determination of scale from images captured by the image sensor of the computing device in which the image sensor does not include a depth sensor. In some implementations, the image sensor may be a front facing camera of a mobile device such as a smart phone or a tablet computing device. In some implementations, the scale may be determined from the images captured by the image sensor of the computing device combined with data provided by an inertial measurement unit (IMU) of the computing device. In some implementations, fixed landmarks may be detected and tracked in a series or sequence of images captured by the image sensor of the computing device. Scale may be determined based on locations of the fixed landmarks in the series of images captured by the image sensor of the computing device, together with data provided by the IMU of the computing device. Determination of scale values in this manner may allow for measurements to be determined based on images captured by the user, without the need for specialized equipment and/or without access to a retail establishment for the fitting of a wearable device. Scale values determined in this manner may serve as a reference from which measurements may be determined for fixed landmarks detected in the image data.

Hereinafter, systems and methods, in accordance with implementations described herein, will be described with respect to the determination of scale from images captured by a handheld computing device for the fitting of a head mounted wearable device, such as, for example, glasses, including smart glasses having display capability and computing capabilities, simply for purposes of discussion and illustration. The principles to be described herein may be applied to the determination of scale from images captured by an image sensor of a computing device operated by a user, for use in a variety of other scenarios including, for example, the fitting of other types of wearable devices (including devices having display and/or computing capabilities), the fitting of apparel items, and the like, which may make use of the front facing camera of the computing device operated by the user. In some situations, the principles to be described herein may be applied to other types of scenarios such as, for example, the accommodation of furnishings in a space, and the like.

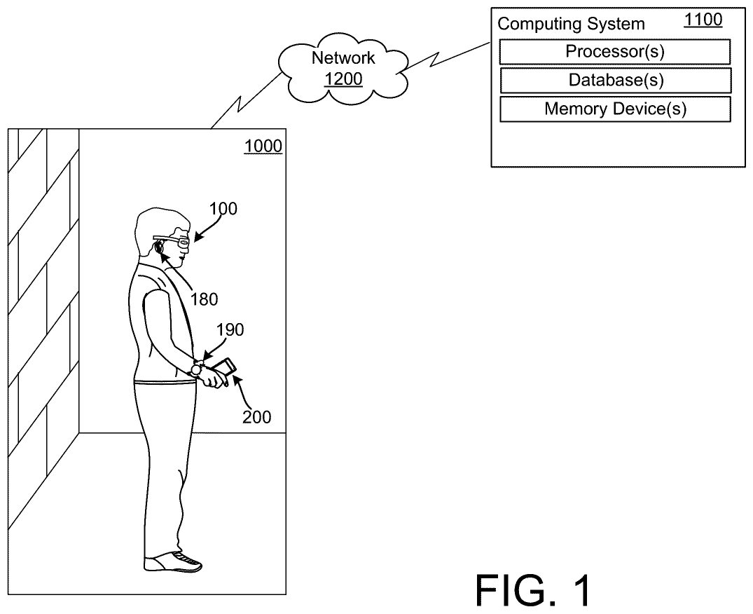

FIG. 1 is a third person view of a user in an ambient environment 1000, with one or more external computing systems 1100 accessible to the user via a network 1200. FIG. 1 illustrates numerous different wearable devices that are operable by the user, including a first wearable device 100 in the form of glasses worn on the head of the user, a second wearable device 180 in the form of ear buds worn in one or both ears of the user, a third wearable device 190 in the form of a watch worn on the wrist of the user, and a handheld computing device 200 held by the user. In some examples, the first wearable device 100 is in the form of a pair of smart glasses including, for example, a display, one or more images sensors that can capture images of the ambient environment, audio input/output devices, user input capability, computing/processing capability and the like. In some examples, the second wearable device 180 is in the form of an ear worn computing device such as headphones, or earbuds, that can include audio input/output capability, an image sensor that can capture images of the ambient environment, computing/processing capability, user input capability and the like. In some examples, the third wearable device 190 is in the form of a smart watch or smart band that includes, for example, a display, an image sensor that can capture images of the ambient environment, audio input/output capability, computing/processing capability, user input capability and the like. In some examples, the handheld computing device 200 can include a display, one or more image sensors that can capture images of the ambient environment, audio input/output capability, computing/processing capability, user input capability, and the like, such as in a smartphone. In some examples, the example wearable devices 100, 180, 190 and the example handheld device 200 can communicate with each other and/or with the external computing system(s) 1100 to exchange information, to receive and transmit input and/or output, and the like. The principles to be described herein may be applied to other types of wearable devices not specifically shown in FIG. 1.

Hereinafter, systems and methods will be described with respect to the detection of scale from images captured by one or more image sensors of the example handheld device 200 operated by the user, for purposes of discussion and illustration. Principles to be described herein may be applied to images captured by other types of computing devices. Hereinafter, systems and methods will be described with respect to the determination of scale from images of the face/head of the user, for example, for the fitting of a head mounted wearable device, simply for purposes of discussion and illustration. Principles to be described herein may be applied to the determination of scale from images including other features and/or combinations of features and/or surroundings. Further, the principles to be described herein may be used to determine scale from images captured by a computing device, together with position and/or acceleration data provided by the computing device, for the fitting of the example wearable devices 100, 180, 190 shown in FIG. 1, as well as other types of wearable devices, apparel items and the like. The principles to be described herein may be similarly used to determine scale from images capture by a computing device, together with position/acceleration data provided by the computing device, for other purposes such as, for example, the scaled insertion of augmented reality items into an augmented reality scene and/or a real world scene, and the like.

In some situations, a user may choose to use a computing device (such as the example handheld computing device 200 shown in FIG. 1, or another computing device) for the virtual selection and fitting of a wearable device, such as the glasses 100 described above. For example, a user may use an application executing on the example computing device 200 to select glasses for virtual try on and fitting. In order to provide for the virtual fitting of a wearable device such as the example glasses, the user may use an image sensor of the example computing device 200 to capture images, for example a series of images, of the face/head of the user. In some examples, the images may be captured by the image sensor via an application executing on the computing device 200. In some examples, fixed features, or landmarks, may be detected within the series of images captured by the image sensor of the computing device 200. In some examples, position and/or orientation data provided by a sensor of the computing device 200 may be combined with the detection of landmarks and/or fixed features in the series of images to determine scale. The combination of the detected landmarks and/or features in the series of images together with the position and/or orientation data associated with the computing device 200 as the series of images are captured, may allow scale to be determined without the use of specialized equipment such as, for example a depth sensor in operation as the images are captured, a pupilometer that can measure interpupillary distance, and the like. The combination of the detected landmarks and/or features in the series of images together with the position and/or orientation data associated with the computing device 200 as the series of images are captured, may allow scale to be determined without the use of a reference object having known scale included in the series of images, a known measure of one or more of the landmarks or features (such as, for example, interpupillary distance), and the like. The ability to accurately determine scale in this manner may simplify the process associated with the fitting of a wearable device such as, for example the glasses 100 as described above, making the wearable device more easily accessible to a wide variety of users.

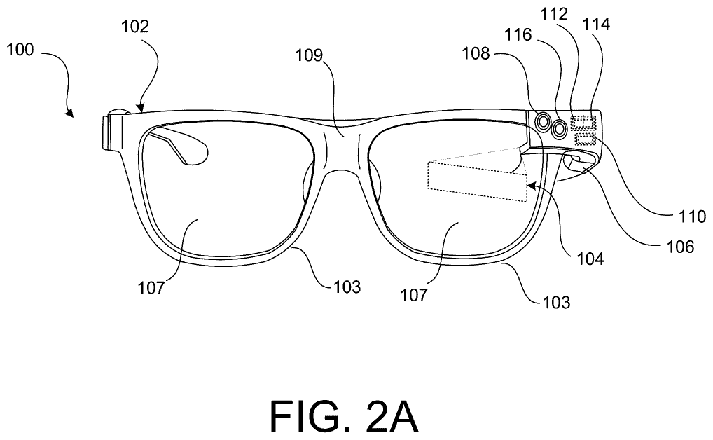

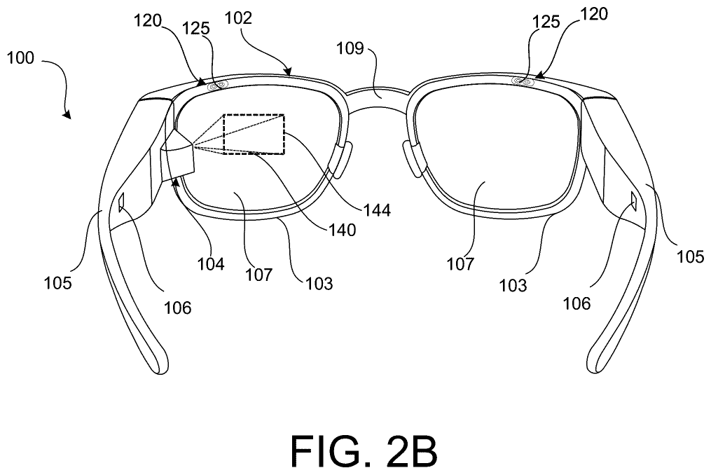

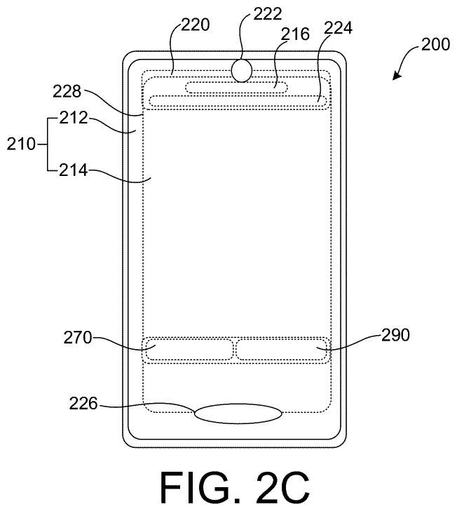

An example head mounted wearable device 100 in the form of a pair of smart glasses is shown in FIGS. 2A and 2B, for purposes of discussion and illustration. The example head mounted wearable device 100 includes a frame 102 having rim portions 103 surrounding glass portion 107, or lenses 107, and arm portions 105 coupled to a respective rim portion 103. In some examples, the lenses 107 may be corrective/prescription lenses. In some examples, the lenses 107 may be glass portions that do not necessarily incorporate corrective/prescription parameters. A bridge portion 109 may connect the rim portions 103 of the frame 102. In the example shown in FIGS. 2A and 2B, the wearable device 100 is in the form of a pair of smart glasses, or augmented reality glasses, simply for purposes of discussion and illustration. The principles to be described herein can be applied to the determination of scale for the fitting of a head mounted wearable device in the form of glasses that do not include the functionality typically associated with smart glasses. The principles to be described herein can be applied to the determination of scale for the fitting of a head mounted wearable device in the form of glasses (including smart glasses, or eyewear that does not include the functionality typically associated with smart glasses) that include corrective/prescription lenses. The principles to be described herein can be applied to the determination of scale for the fitting of a head mounted wearable device in the form of glasses (including smart glasses, or eyewear that does not include the functionality typically associated with smart glasses) that include corrective/prescription lenses.

The example wearable device 100, in the form of smart glasses as shown in FIGS. 2A and 2B, includes a display device 104 coupled in a portion of the frame 102, with an eye box 140 extending toward at least one of the lenses 107, for output of content at an output coupler 144 at which content output by the display device 104 may be visible to the user. In some examples, the output coupler 144 may be substantially coincident with the lens(es) 107. In this form, the wearable device 100 can also include an audio output device 106 (such as, for example, one or more speakers), an illumination device 108, a sensing system 110, a control system 112, at least one processor 114, and an outward facing image sensor 116, or camera 116. In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 107, next to content (for example, digital images, user interface elements, virtual content, and the like) generated by the display device 104. In some implementations, waveguide optics may be used to depict content on the display device 104. In some examples, a gaze tracking device 120 including, for example, one or more sensors 125, may detect and track eye gaze direction and movement. Data captured by the sensor(s) 125 may be processed to detect and track gaze direction and movement as a user input. In some implementations, the sensing system 110 may include various sensing devices and the control system 112 may include various control system devices including, for example, one or more processors 114 operably coupled to the components of the control system 112. In some implementations, the control system 112 may include a communication module providing for communication and exchange of information between the wearable device 100 and other external devices.

The example wearable device 100 can include more, or fewer features than described above. The principles to be described herein are applicable to the determination of scale for the virtual sizing and fitting of head mounted wearable devices including computing capabilities, i.e., smart glasses, and also to head mounted wearable devices that do not include computing capabilities, and to head mounted wearable devices with or without corrective lenses.

FIG. 2C is a front view of an example computing device, in the form of the example handheld computing device 200 shown in FIG. 1. The example computing device 200 may include an interface device 210. In some implementations, the interface device 210 may function as an input device, including, for example, a touch surface 212 that can receive touch inputs from the user. In some implementations, the interface device 210 may function as an output device, including, for example, a display portion 214 allowing the interface device 210 to output information to the user. In some implementations, the interface device 210 can function as an input device and an output device. The example computing device 200 may include an audio output device 216, or speaker, that outputs audio signals to the user.

The example computing device 200 may include a sensing system 220 including various sensing system devices. In some examples, the sensing system devices include, for example, one or more image sensors, one or more position and/or orientation sensors, one or more audio sensors, one or more touch input sensors, and other such sensors. The example computing device 200 shown in FIG. 2C includes an image sensor 222. In the example shown in FIG. 2C, the image sensor 222 is a front facing camera. The example computing device 200 may include additional image sensors such as, for example, a world facing camera. The example computing device 200 shown in FIG. 2C includes an inertial measurement unit (IMU) 224 including, for example, position and/or orientation and/or acceleration sensors such as, for example, an accelerometer, a gyroscope, a magnetometer, and other such sensors that can provide position and/or orientation and/or acceleration data. The example computing device 200 shown in FIG. 2C includes an audio sensor 226 that can detect audio signals, for example, for processing as user inputs. The example computing device 200 shown in FIG. 2C includes a touch input sensor 228, for example corresponding to the touch surface 212 of the interface device 210. The touch input sensor 228 can detect touch input signals for processing as user inputs. The example computing device 200 may include a control system 270 including various control system devices. The example computing device 200 may include a processor 290 to facilitate operation of the computing device 200.

As noted above, a computing device such as the example handheld computing device 200 may be used to capture images of the user, for the determination of scale, allowing the user to then use the computing device 200 for the virtual selection and fitting of a wearable device such as the glasses 100 described above, without the need for specialized equipment, a proctored virtual fitting, access to a retail establishment, and the like.

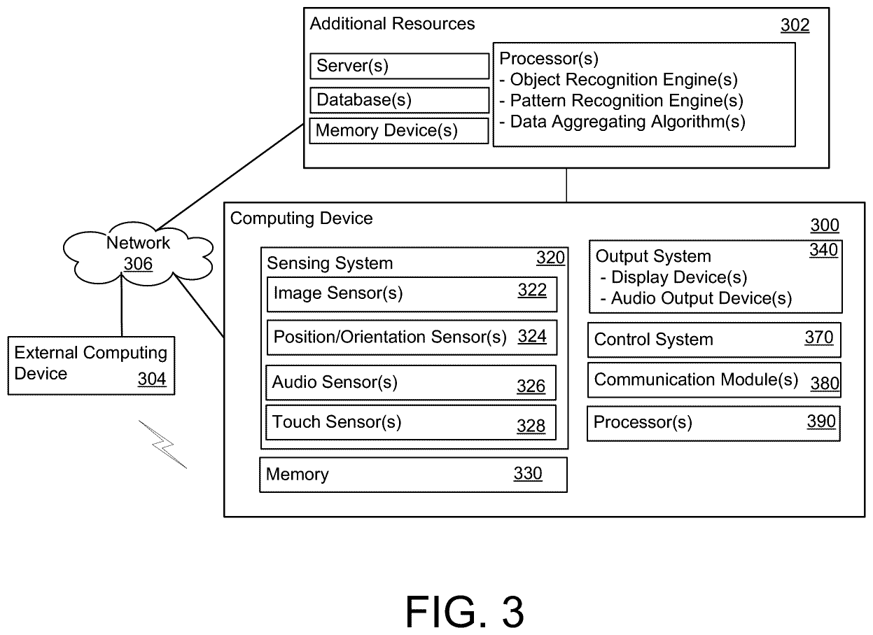

FIG. 3 is a block diagram of an example system for determining scale from images captured by a computing device. The system may make use of the scale for the fitting of wearable devices based on the captured images. The wearable devices to be fitted based on the scale determined in this manner can include various wearable computing devices as described above. The wearable devices to be fitted based on the scale determined in this manner can include other types of wearable devices such as clothing, accessories and the like, as well as other scenarios in which depth imaging and/or a reference device having a known scale is not available.

The system may include a computing devices 300. The computing device 300 can access additional resources 302 to facilitate the determination of scale as described. In some examples, the additional resources may be available locally on the computing device 300. In some examples, the additional resources may be available to the computing device 300 via a network 306. In some examples, some of the additional resources 302 may be available locally on the computing device 300, and some of the additional resources 302 may be available to the computing device 300 via the network 306. The additional resources 302 may include, for example, server computer systems, processors, databases, memory storage, and the like. The computing device 300 can operate under the control of a control system 370. The computing device 300 can communicate with one or more external devices 304 (another wearable computing device, another mobile computing device and the like) either directly (via wired and/or wireless communication), or via the network 306. In some implementations, the computing device 300 includes a communication module 380 to facilitate external communication. In some implementations, the computing device 300 includes a sensing system 320 including various sensing system components including, for example one or more image sensors 322, one or more position/orientation sensor(s) 324 (including for example, an inertial measurement unit, accelerometer, gyroscope, magnetometer and the like), one or more audio sensors 326 that can detect audio input, one or more touch input sensors 328 that can detect touch inputs, and other such sensors. The computing device 300 can include more, or fewer, sensing devices and/or combinations of sensing devices.

In some implementations, the computing device 300 may include one or more image sensor(s) 322. The image sensor(s) 322 may include, for example, cameras such as, for example, forward facing cameras, outward, or world facing cameras, and the like that can capture still and/or moving images of an environment outside of the computing device 300. The still and/or moving images may be displayed by a display device of an output system 340, and/or transmitted externally via a communication module 380 and the network 306, and/or stored in a memory 330 of the computing device 300. The computing device 300 may include one or more processor(s) 390. The processors 390 may include various modules or engines configured to perform various functions. In some examples, the processor(s) 390 may include object recognition module(s), pattern recognition module(s), configuration identification modules(s), and other such processors. The processor(s) 390 may be formed in a substrate configured to execute one or more machine executable instructions or pieces of software, firmware, or a combination thereof. The processor(s) 390 can be semiconductor-based including semiconductor material that can perform digital logic. The memory 330 may include any type of storage device that stores information in a format that can be read and/or executed by the processor(s) 390. The memory 330 may store applications and modules that, when executed by the processor(s) 390, perform certain operations. In some examples, the applications and modules may be stored in an external storage device and loaded into the memory 330.

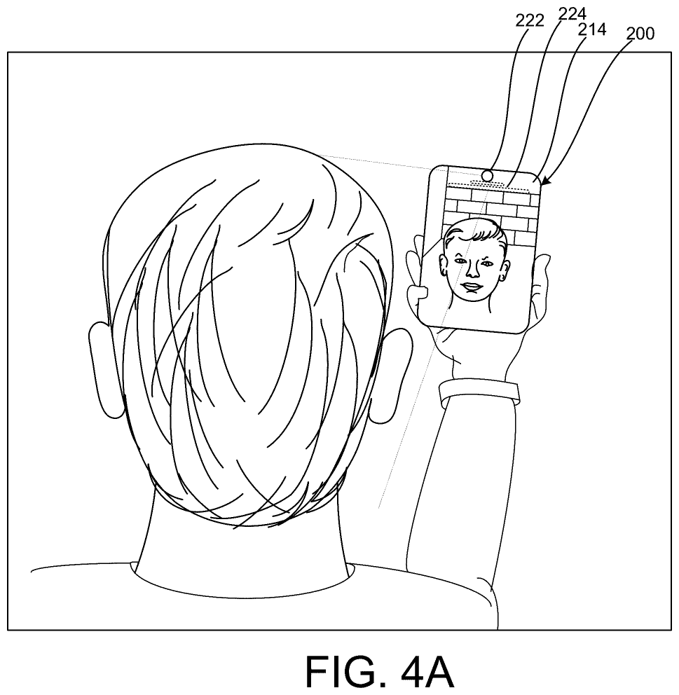

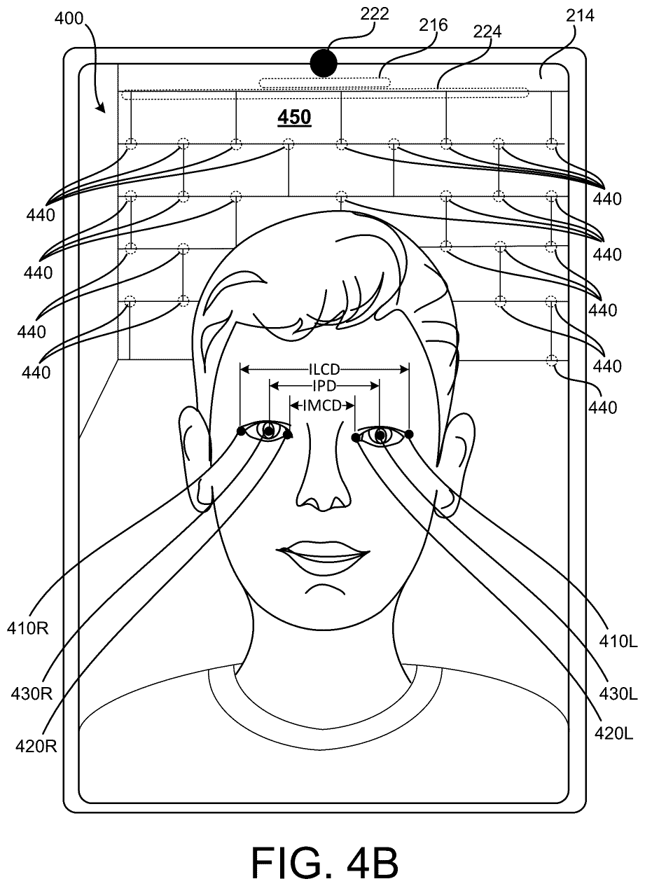

FIG. 4A illustrates the use of a computing device, such as the example handheld computing device 200 shown in FIGS. 1A and 2C, to capture images for the virtual selection and/or fitting of a wearable device such as the example head mounted wearable device 100 shown in FIGS. 1A, 2 and 2B. In particular, FIG. 4A illustrates the use of a computing device to capture images, using a front facing camera of the computing device, without the use of a reference object having a known scale and/or specialized equipment such as a depth sensor, a pupilometer and the like, for the determination of scale to be used for the virtual selection and/or fitting of a wearable device. As noted above, the principles described herein can be applied to other types of computing devices and/or to the selection and/or fitting of other types of wearable devices.

In the example shown in FIG. 4A, the user is holding the example handheld computing device 200 so that the head and face of the user is in the field of view of the image sensor 222 of the computing device 200. In particular, the head and face of the user is in the field of view of the image sensor 222 of the front facing camera of the computing device 200, so that the image sensor 222 can capture images of the head and face of the user. The images captured by the image sensor 222 may be displayed to the user on the display portion 214 of the computing device 200, so that the user can verify that the initial positioning of the head and face within the field of view of the image sensor 222. FIG. 4B illustrates an example image frame 400 captured by the image sensor 222 of the computing device 200 during an image data capture process using the computing device 200 operated by the user as shown in FIG. 4A. The image data captured by the image sensor 222 may be processed, for example, by resources available to the computing device 200 as described above (for example, the additional resources 302 described above with respect to FIG. 3) to detect scale, for use in the virtual selection and/or fitting of a wearable device. In some examples, the capture of images and the accessing of the additional resources may be performed via an application executing on the computing device 200.A

Systems and methods, in accordance with implementations described herein, may detect one or more features, or landmarks, within a series of images, or image frames, captured in this manner. One or more algorithms may be applied to combine the one or more features and/or landmarks with position and/or orientation data provided by sensors such as, for example, position and/or orientation sensors included in the IMU 224 of the computing device 200, as the series of images are captured. Output of the algorithm(s) may be aggregated to make a determination of scale.

As shown in FIG. 4B, the image data captured by the image sensor 222 may be processed, for example, by a recognition engine of the additional resources 302, to detect and/or identify various fixed features and/or landmarks in the image data/series of image frames captured by the image sensor 222. In the example shown in FIG. 4B, various example facial landmarks have been identified in the example image frame 400. The example facial landmarks may represent facial landmarks that remain substantially fixed, even in the event of changes in facial expression and the like. In the example shown in FIG. 4B, example facial landmarks include a first landmark 410R representing an outer corner of the right eye, and a second landmark 410L representing an outer corner of the left eye. A distance between the first landmark 410R and the second landmark 410L may represent an inter-lateral commissure distance (ILCD). The first landmark 410R and the second landmark 410R remain relatively fixed, or relatively stable, regardless of eye gaze direction. Thus, the resulting ILCD may also remain relatively fixed, or relatively stable, across a series of image frames captured by the image sensor 222.

In the example shown in FIG. 4B, example facial landmarks include a third landmark 420R representing an inner corner of the right eye, and a fourth landmark 420L representing an inner corner of the left eye. A distance between the third landmark 420R and the fourth landmark 420L may represent an inter-medial commissure distance (IMCD). The third landmark 420R and the fourth landmark 420R remain relatively fixed, or relatively stable, regardless of eye gaze direction. Thus, the resulting IMCD may also remain relatively fixed, or relatively stable, across a series of image frames captured by the image sensor 222.

In the example shown in FIG. 4B, example facial landmarks include a fifth landmark 430R representing a pupil center of the right eye, and a sixth landmark 430L representing a pupil center of the left eye. A distance between the fifth landmark 430R and the sixth landmark 430R may represent an inter-pupillary distance. Inter-pupillary distance may remain relatively fixed, or relatively stable, in a situation in which user gaze is focused on a point in the distance as the series of images are captured by the image sensor 222.

In the example shown in FIG. 4B, example fixed, or static key points, or, features, or elements 440 are identified in a background 450 of the image data captured by the image sensor 222. In the example shown in FIG. 4B, the fixed, or static key points, or, features, or elements 440 represent relatively clearly defined features, for example, clearly defined geometric features such as corners, intersections and the like, that remain fixed, or stable, across the series of image frames captured by the image sensor 222.

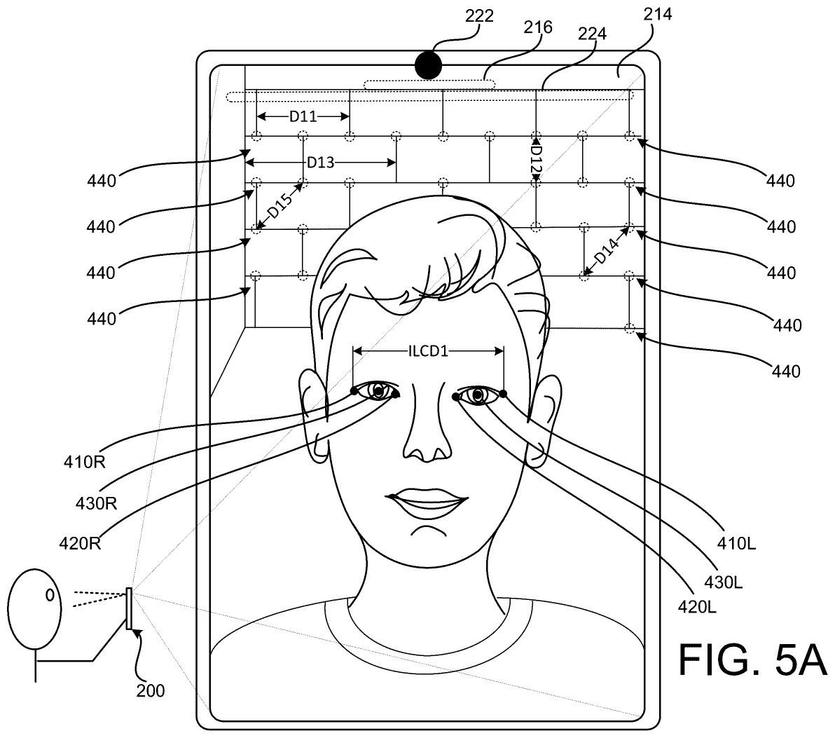

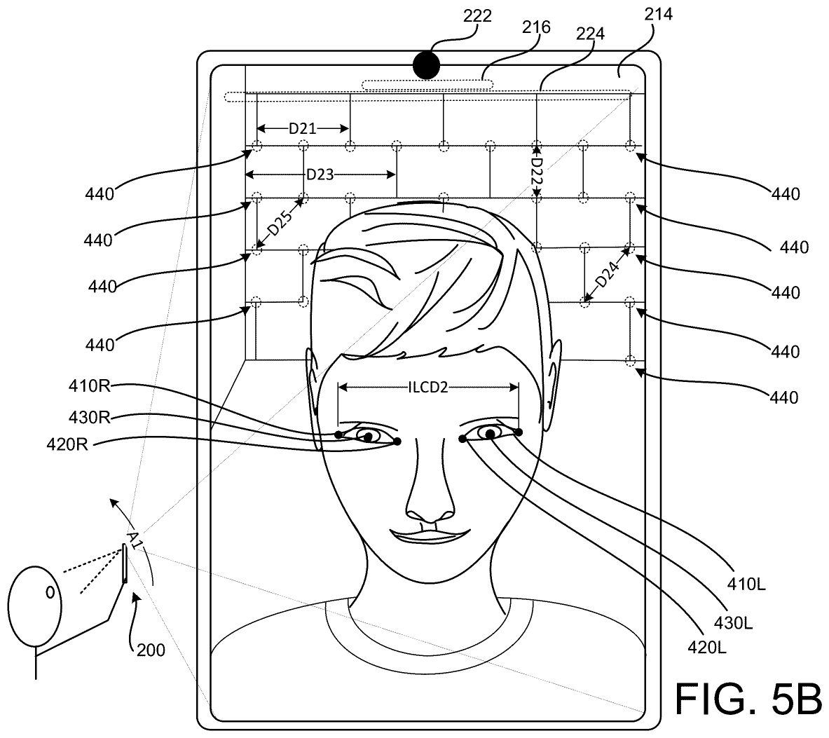

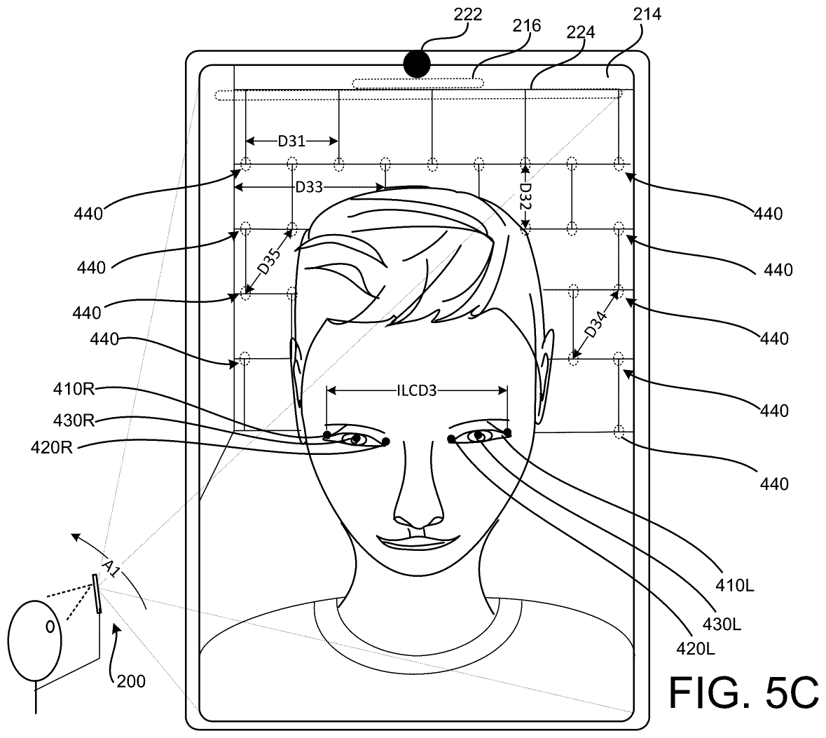

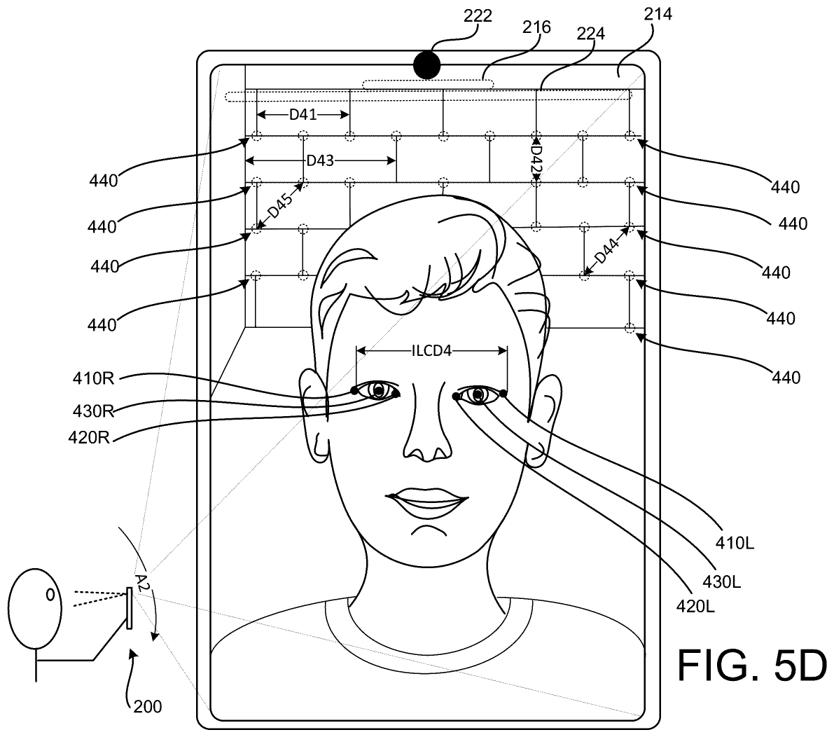

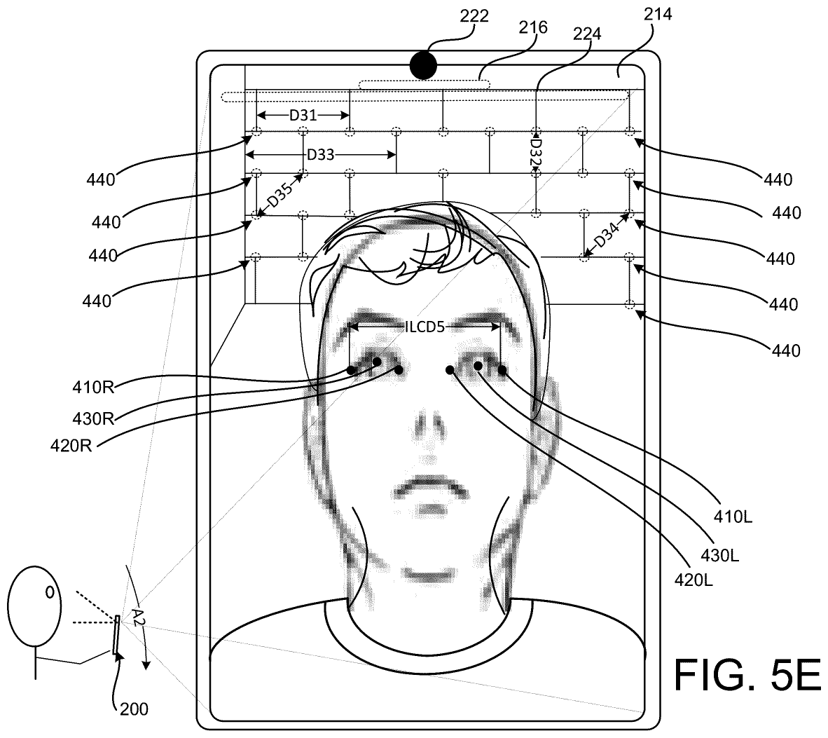

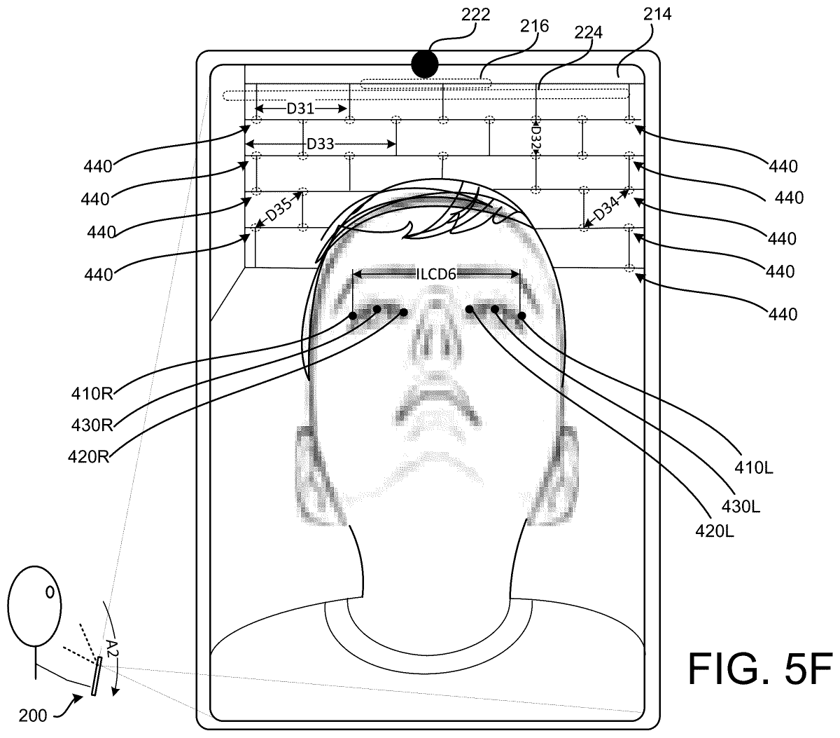

FIGS. 5A-5F illustrate the use of a computing device, such as the example handheld computing device 200 shown in FIGS. 1A and 2C, to capture image data for the determination of scale, without the use of a reference object having a known scale and/or specialized equipment such as a camera equipped with a depth sensor, a pupilometer, and the like. In particular, FIGS. 5A-5F illustrate the use of the example handheld computing device 200 to capture image data for the determination of scale, for use in the virtual selection and/or fitting of a wearable device such as the example head mounted wearable device 100 shown in FIGS. 1A, 2A and 2B.

In the example shown in FIG. 5A, the user has initiated the capture of image data to be used in the determination of scale. In FIG. 5A, the computing device 200 is positioned so that the head and face of the user is captured within the field of view of the image sensor 222. In the example shown in FIG. 5A, the image sensor 222 is included in the front facing camera of the computing device 200, and the head and face of the user are captured within the field of view of the front facing camera of the computing device 200. In the initial position shown in FIG. 5A, the computing device 200 is positioned substantially straight out from the head and face of the user, somewhat horizontally aligned with the head and face of the user, simply for purposes of discussion and illustration. The capture of image data by the image sensor 222 of the computing device 200 can be initiated at other positions of the computing device 200 relative to the head and face of the user.

In the position shown in FIGS. 5B and 5C, the user has moved, for example, sequentially moved, the computing device 200 in the direction of the arrow A1, while the head and face of the user remain in substantially the same position. As the computing device 200 is moved from the position shown in FIG. 5A to the position shown in FIG. 5B and then to the position shown in FIG. 5C, the image sensor 222 captures, for example, sequentially captures, image data of the head and face of the user from the different positions and/or orientations of the computing device 200/image sensor 222. FIGS. 5B and 5C show just two example image frames 400 captured by the image sensor 222 as the user moves the computing device 200 in the direction of the arrow A1, while the head and face of the user remain substantially stationary. Any number of image frames 400 may be captured by the image sensor 222 as the computing device 200 is moved in the direction of the arrow A1. Similarly, any number of image frames 400 captured by the image sensor 222 may be analyzed and processed by the recognition engine to detect and/or identify the features 410 and/or the features 420 and/or the features 430 and/or the features 440 in the sequentially captured image frames 400 as the computing device 200 is moved in this manner.

In FIGS. 5D-5F, the computing device 200 has been moved, for example, sequentially moved, in the direction of the arrow A2. As the computing device 200 is moved in the direction of the arrow A2, the head of the user remains in substantially the same position. As the computing device 200 is moved in the direction of the arrow A2, the image sensor 222 captures image data of the head and face of the user from corresponding perspectives of the computing device 200/image sensor 222 relative to the head and face of the user. Thus, as the computing device 200 is sequentially moved in the direction of the arrow A1, and then in the direction of the arrow A2, the image sensor 222 captures image data including the head and face of the user from the various different perspectives of the computing device 200/image sensor 222, while the position and/or orientation of head and face of the user remain substantially the same. FIGS. 5D-5F 5C show just three example image frames 400 captured by the image sensor 222 as the user moves the computing device 200 in the direction of the arrow A2, while the head and face of the user remain substantially stationary. Any number of image frames 400 may be captured by the image sensor 222 as the computing device 200 is moved in the direction of the arrow A2. Similarly, any number of image frames 400 captured by the image sensor 222 may be analyzed and processed by the recognition engine to detect and/or identify the features and/or the features 420 and/or the features 430 and/or the features 440 in the sequentially captured image frames 400 as the computing device 200 is moved in this manner.

The image data captured by the image sensor 222 of the computing device 200 as the computing device 200 is moved as shown in FIGS. 5A-5F may be processed, for example, by a recognition engine accessible to the computing device 200 (for example, via the external computing systems 1100 described above with respect to FIG. 1, or via the additional resources 302 described above with respect to FIG. 3). Landmarks and/or features may be detected in the image data captured by the image sensor 222 through the processing of the image data. The detected landmarks and/or features may be landmarks and/or features that are substantially fixed, or substantially unchanging, or substantially constant. The example landmarks 410, 420, 430 and the example features 440 illustrate some example landmarks and/or features that may be detected in the sequentially captured frames of image data captured by the image sensor 222.

As noted above, one example feature may include the ILCD, representing a distance between the outer corners of the eyes of the user. Another example feature may include the IMCD, representing a distance between the inner corners of the eyes of the user. The ILCD and the IMCD may remain substantially constant, even in the event of changes in facial expression, changes in gaze direction, intermittent blinking and the like. As noted above, IPD may remain substantially constant, provided a distance gaze is maintained. Other example landmarks or features may include various fixed elements 440 detected in the background 450, or the area surrounding the head and face of the user. In the example shown in FIGS. 5A-5F, the fixed elements 440 are geometric features detected in the background 450, or the area surrounding the user, simply for purposes of discussion and illustration. The fixed elements may include other types of elements detected in the background 450. For example, in FIGS. 5A-5F, the fixed elements 440 are geometric features (lines, edges, corners and the like) detected in a repeating pattern in the background 450, simply for purposes of discussion and illustration. In some examples, other fixed elements, features and the like may be detected in the background, including, for example, features in a room (corners between adjacent walls, corners where the wall meets the floor and/or the ceiling, and the like), windows, frames, furniture, and other elements having defined features that are detectable in the image data captured by the image sensor 222.

These elements having fixed contours and/or geometry in the area surrounding the head and face of the user that may be detected in the frames of image data captured by the image sensor 222. Detected features and/or landmarks, and changes in the frames of image data sequentially captured by the image sensor 222 as the computing device 200 is moved, can be correlated with position and/or orientation data provided by the position and/or orientation sensors included in the IMU 224 of the computing device 200 at positions corresponding to the capture of the image data.

In some examples, data provided by the position and/orientation sensors included in the IMU 224, together with the processing and analysis of the image data, may be used to provide the user with feedback so that scale may be more accurately determined. For example, based on data provided by position and/or orientation sensors included in the IMU 224 of the computing device 200 together with the fixed landmarks and/or features detected in the image data and the subsequent aggregation of data performed by the algorithms for determination of scale, one or more prompts may be output to the user. These prompts may include, for example, a prompt indicating that the user repeat the image data collection sequence. These prompts may include, for example, a prompt providing further instruction as to the user's motion of the computing device 200 during the image data collection sequence. These prompts may include, for example, a prompt indicating a change in the ambient environment may produce improved results such as, for example, a change to include fixed features in the background 450, a change in illumination and the like. In some examples, the prompts may be visual prompts output on the display portion 214 of the computing device 200. In some examples, the prompts may be audible prompts output by the audio output device 216 of the computing device 200.

The image data captured in the manner described above may allow scale to be determined using the computing device 200 operated by the user, for the selection and/or fitting of the wearable device without the use of specialized equipment such as a depth sensor, a pupilometer and the like, without the use of a reference object having a known scale, without relying on access to a retail establishment, and without relying on a proctor to supervise the capture of the image data and/or to capture the image data. Rather, the image data may be captured by the image sensor 222 of the computing device 200 operated by the user, and in particular, by the image sensor 222 included in the front facing camera of the computing device 200.

A depth map of the face/head of the user may be generated based on a series of image frames including image data captured from different positions of the computing device 200 relative to the head and/or face of the user. The fixed landmarks and/or features detected in the image data obtained in this manner may be tracked, and correlated with data provided by position and/or orientation sensors included in the IMU 224 of the computing device 200 to generate a depth map and determine scale.

In some examples, the frames of image data collected in this manner may be analyzed and processed, for example, by object and/or pattern recognition engines provided in the additional resources 302 accessible to the computing device 200 to detect the landmarks and/or features in the sequentially captured image frames. Data provided by the position and/or orientation sensors included in the IMU 224 may be combined with the image data. In particular, the data provided by the position and/or orientation sensors of the IMU 224 may be associated with the detected landmarks and/or features in the sequential frames of image data. This combined data may be aggregated, for example, by one or more algorithms applied by a data aggregating engine of the additional resources 302, to generate an estimate of scale.

For example, an ILCD1, based on the fixed facial landmarks 410R, 410L, is associated with the first position shown in FIG. 5A. Similarly, a particular position is associated with each of the detected fixed elements 440 in the background 450, and relative positions of the plurality of fixed elements 440 in the background. This is represented in FIG. 5A, simply for illustrative purposes, by a distance D11 between a first pair of the fixed elements 440, a distance D12 between a second pair of the fixed elements 440, a distance D13 between a third pair of the fixed elements 440, a distance D14 between a fourth pair of the fixed elements 440, and a distance D15 between a fifth pair of the fixed elements 440. A first position and a first orientation may be associated with the computing device at the first position shown in FIG. 5A, based on data provided by the IMU 224. The position and orientation of the computing device 200 at the first position shown in FIG. 5A may in turn be associated with the facial landmarks 410R, 410L and the associated ILCD1, and with the plurality of fixed elements 440 and the associated distances D11, D12, D13, D13 and D15.

As the computing device is moved from the first position shown in FIG. 5A to the second position shown in FIG. 5B, a second position and a second orientation of the computing device 200 are associated with the computing device 200 based on data provided by the IMU 224. A motion stereo baseline can be determined based on the first position and second orientation and the second position and second orientation of the computing device 200. As the computing device 200 is moved relative to the head and face of the user from the first position shown in FIG. 5A to the second position shown in FIG. 5B, the image data captured by the image sensor 222 changes, so that the respective positions of the landmarks 410R, 410L, 420R, 420L, 430R, 430L and elements 440 change within the image frame 400. This in turn causes a change from the ILCD1 shown in FIG. 5A to the ILCD2 shown in FIG. 5B. Similarly, this causes a change in the example distances associated with the example pairs of elements 440, from D11, D12, D13, D14 and D15 shown in FIG. 5A, to D21, D22, D23, D24 and D25 shown in FIG. 5B. In FIG. 5B, the relative second positions of the landmarks 410R, 410L, 420R, 420L, 430R, 430L and elements 440 (and corresponding distances ILCD2, D21, D22, D23, D24 and D25) can be correlated with the corresponding movement of the computing device 200 from the first position and first orientation to the second position and second orientation. That is, the known change in position and orientation of the computing device 200, from the first position/orientation to the second position/orientation, may be correlated with a known amount of linear rotation (for example, based on gyroscope data from the IMU 224) and linear acceleration (for example, from accelerometer data from the IMU 224) to provide a first reference source for scale. Thus, the detected change in position of the landmarks 410R, 410L, 420R, 420L, 430R, 430L and elements 440 (and corresponding distances ILCD2, D21, D22, D23, D24 and D25) may be determined, using the detected known change in position and orientation of the computing device 200 as a baseline for first scale value.

Additional data may be obtained as the user continues to move the computing device 200 further in the direction of the arrow A1, i.e., substantially vertically, from the second position and second orientation shown in FIG. 5B to the third position and third orientation shown in FIG. 5C, while holding their head substantially still. As the computing device 200 is moved relative to the head and face of the user from the second position shown in FIG. 5B to the third position shown in FIG. 5C, image data captured by the image sensor 222 changes, so that the respective positions of the landmarks 410R, 410L, 420R, 420L, 430R, 430L and elements 440 change within the image frame 400. This in turn causes a change from the ILCD2 shown in FIG. 5B to the ILCD3 shown in FIG. 5C. Similarly, this causes a change in the example distances associated with the example pairs of elements 440, from D21, D22, D23, D24 and D25 shown in FIG. 5B to D31, D32, D33, D34 and D35 shown in FIG. 5C. The relative third positions of the landmarks 410R, 410L, 420R, 420L, 430R, 430L and elements 440 (and corresponding distances ILCD3, D31, D32, D33, D34 and D35) can be correlated with the corresponding movement of the computing device 200. That is, the known change in position and orientation of the computing device 200, from the second position/orientation to the third position/orientation, based on a known amount of linear rotation (for example, based on gyroscope data from the IMU 224) and linear acceleration (for example, from accelerometer data from the IMU) may provide another reference source for scale. The detected change in position of the landmarks 410R, 410L, 420R, 420L, 430R, 430L and elements 440 (and corresponding distances ILCD3, D31, D32, D33, D34 and D35) may be determined, using the detected known change in position and orientation of the computing device 200 as a baseline for a second scale value.

Data may continue to be obtained as the user continues to move the computing device 200. In this example, the user changes direction, and moves the computing device 200 in the direction of the arrow A2, as shown in FIGS. 5D, 5E and substantially vertically, from the third position and third orientation shown in FIG. to the fourth position/orientation shown in FIG. 5D, a fifth position/orientation shown in FIG. 5D, and a sixth position/orientation shown in FIG. 5E, while holding their head substantially still. As the computing device 200 is moved relative to the head and face of the user as shown in FIGS. 5D-5F, image data captured by the image sensor 222 changes, so that the respective positions of the landmarks 410R, 410L, 420R, 420L, 430R, 430L and elements 440 change within the image frame 400. This in turn causes a sequential change from the ILCD3 shown in FIG. 5C, to the ILCD4, ILDC5 and ILDC6 shown in FIGS. 5D-5F. Similarly, this causes a sequential change in the example distances associated with the example pairs of elements 440, from D31, D32, D33, D34 and D35 shown in FIG. 5C, to D41/D42/D43/D44/D45 shown in FIG. 5D, D51/D52/D53/D54/D55 shown in FIG. 5E, and D61/D62/D63/D64/D65 shown in FIG. 5F. The relative positions of the landmarks 410R, 410L, 420R, 420L, 430R, 430L and elements 440 (and corresponding distances) can again be correlated with the corresponding movement of the computing device 200, with known positions and orientations of the computing device 200 as the computing device 200 is moved as shown, based on a known amount of linear rotation (for example, based on gyroscope data from the IMU 224) and linear acceleration (for example, from accelerometer data from the IMU) may provide additional reference sources for scale. The detected changes in positions of the landmarks 410R, 410L, 420R, 420L, 430R, 430L and elements 440 (and corresponding distances) as the computing device 200 is moved in the direction of the arrow A2 as shown in FIGS. 5D-5F, may be determined, using the detected known changes in position and orientation of the computing device 200 as a baseline for an example third scale value (FIG. 5D), and example fourth scale value (FIG. 5E), and an example fifth scale value (FIG. 5F).

The example shown in FIGS. 5A-5F describes six example data collection points, simply for ease of discussion and illustration. In some examples, image data and position and orientation data may be obtained at more, or fewer, points as the computing device 200 is moved. In some examples, image data and position and orientation data may be substantially continuously obtained, with corresponding scale values being substantially continuously determined.

A plurality of scale values, detected in this manner, may be aggregated, for example, by a data aggregating engine and associated algorithms available via the additional resources 302 accessible to the computing device 200. The image data, and the associated position and orientation data, may continue to be collected until the aggregated scale values determined in this manner coalesce to provide a robust, and relatively reliable determination of scale.

Systems and methods, in accordance with implementations described herein, may provide an accurate determination of scale from image data combined with position and/or orientation data provided by one or more sensors of the computing device 200. In the examples described above, image data of the head and face of the user is obtained by the image sensor 222 of a front facing camera of the computing device 200. In some situations, the collection of image data in this manner may pose challenges due to, for example, the relative proximity between the image sensor 222 of the front facing camera and the head/face of the user, inherent, natural movement of the head and face of the user as the computing device 200 is moved, combined with the need for accuracy in the determination of scale, particularly for the accurate fitting of head mounted wearable devices. The use of static key points, or elements, or features, in the background that anchor the captured image data as the computing device 200 is moved and sequential frames of image data are captured, may increase the accuracy of the scale values determined from the image data and position/orientation data. The collection of multiple frames of image data including the fixed facial landmarks and the static key points or features or elements in the background, and the combining of the image data with corresponding position/orientation data associated with the computing device 200 as the series of frames of image data is collected, may provide a plurality of estimated scale values. The aggregated estimated scale values may coalesce at a scale value that provides for a relatively accurate determination of scale within the image data.

In the examples described above, the movement of the computing device 200 is in a substantially vertical direction, in front of the user, such that the user while the head and face of the user remain substantially still, or static. The image data obtained through the example movement of the computing device 200 as shown in FIGS. 5A-5E (i.e., substantially vertically in front of the user) may provide for the relatively clear and detectable capture of the fixed facial landmarks and/or static key points/fixed elements in the background from the changing perspective of the computing device relative to the head/face of the user as the computing device 200 is moved. In some examples, systems and methods, in accordance with implementations described herein, may be accomplished using other movements of the computing device 200 relative to the user.

Systems and methods, in accordance with implementations described herein, have been presented with respect to a determination of scale for the fitting of a head mounted wearable device, simply for purposes of discussion and illustration. The principles described herein may be applied to the determination of scale for other types of wearable devices, and to the determination of scale for other types of products, for which an accurate determination of scale may be beneficial. Similarly, systems and methods, in accordance with implementations described herein, have been presented using ILCD as an example fixed facial landmark, simply for purposes of discussion and illustration. Other facial landmarks may also be applied, alone, or together with ILCD, to accomplish the disclosed determination of scale.

Systems and methods, in accordance with implementations described herein, provide for the determination of scale from image data and position/orientation data using a client computing device. Systems and methods, in accordance with implementations described herein, may determine scale from image data and position/orientation data without the use of a known reference object. Systems and methods, in accordance with implementations described herein, may determine scale from image data and position/orientation data without the use of specialized equipment such as, for example, depth sensors, pupilometers and the like that may not be readily available to the user. Systems and methods, in accordance with implementations described herein, may determine scale from image data and position/orientation data without the need for a proctored virtual fitting and/or access to a physical retail establishment. Systems and methods, in accordance with implementations describe herein, may improve accessibility to the virtual selection and accurate fitting of wearable devices. The determination of scale in this manner provides for a virtual try on of an actual wearable device to determine wearable fit and/or ophthalmic fit and/or display fit of the wearable device, rather than a simple re-sizing and super-imposing of an image of a wearable device on an image of a user that does not take actual fit into account.

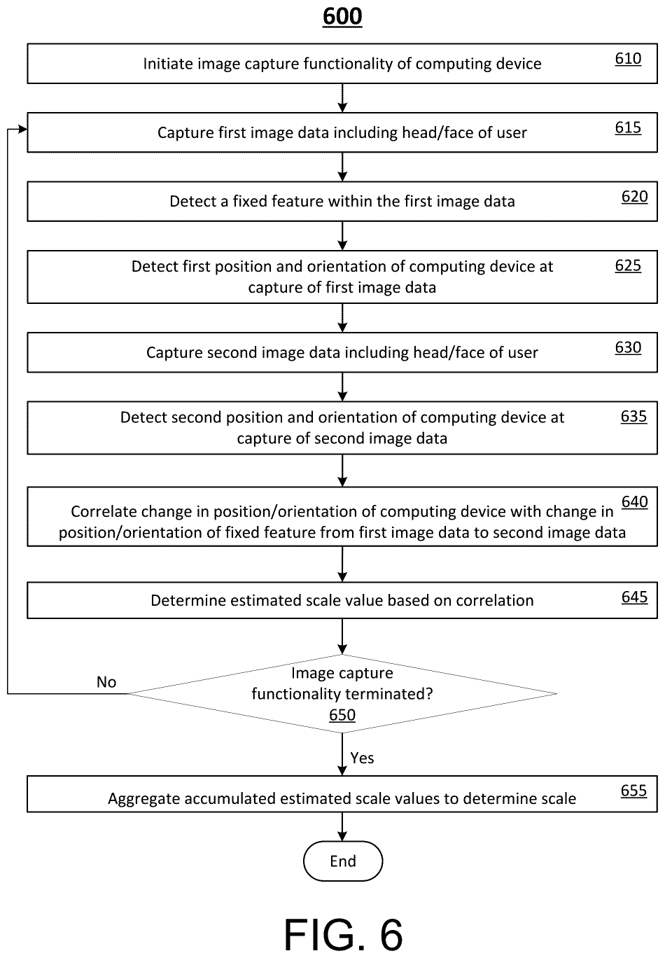

FIG. 6 is a flowchart of an example method 600 of determining scale from image data and position/orientation data. A user operating a computing device (such as, for example, the computing device 200 described above) may initiate image capture functionality of the computing device (block 610). Initiation of the image capture functionality may cause an image sensor (such as, for example, the image sensor 222 of the front facing camera of the computing device 200 described above) to capture first image data including a face and/or a head of the user (block 615). One or more fixed features may be detected within the first image data (block 620). The one or more fixed features may include fixed facial features and/or landmarks that remain substantially static, and/or fixed or static key points or features in a background area surrounding the head/face of the user in the first image data. A first position and orientation of the computing device may be detected (block 625) based on, for example, data provided by position/orientation sensors of the computing device at a point corresponding to capture of the first image data.

Continued operation of the image capture functionality may cause the computing device to capture second image data including the face and/or a head of the user and the fixed feature (block 630). A second position and orientation of the computing device may be detected (block 635) based on, for example, data provided by position/orientation sensors of the computing device at a point corresponding to capture of the second image data. A change in the position and the orientation of the computing device, from first position/orientation to the second position/orientation, may be correlated with a change in position of the fixed feature detected in the first image data and the second image data (block 640). The correlation may form a basis for determination of an estimated scale value (block 645). Image data capture, identification of fixed features, correlation, and determination of estimated scale values may continue until the image data functionality is terminated (block 650). The accumulated estimated scale values may be aggregated to determine an accurate scale.

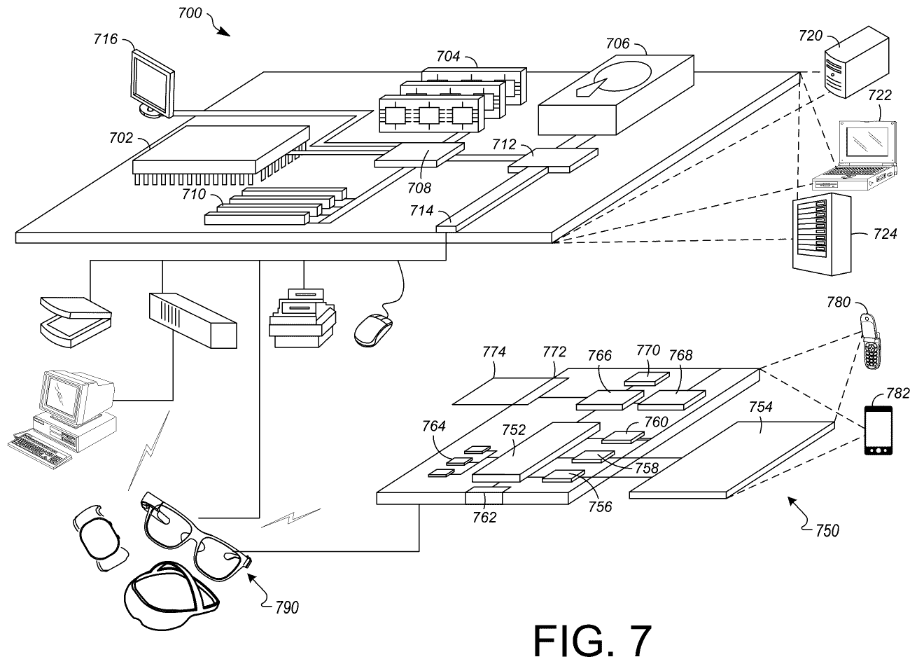

FIG. 7 illustrates an example of a computer device 700 and a mobile computer device 750, which may be used with the techniques described here. The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), and LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 790 to generate an augmented environment for viewing inserted content within the physical space. For example, one or more sensors included on a computing device 750 or other computing device depicted in the figure, can provide input to the AR headset 790 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 750 can use the sensors to determine an absolute position and/or a detected rotation of the computing device in the AR space that can then be used as input to the AR space. For example, the computing device 750 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 750 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the AR space can cause a particular action to occur in the AR space.

In some implementations, a touchscreen of the computing device 750 can be rendered as a touchpad in AR space. A user can interact with the touchscreen of the computing device 750. The interactions are rendered, in AR headset 790 for example, as movements on the rendered touchpad in the AR space. The rendered movements can control virtual objects in the AR space.

In some implementations, one or more output devices included on the computing device 750 can provide output and/or feedback to a user of the AR headset 790 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the AR space. In the example of the laser pointer in an AR space, the computing device 750 appears as a virtual laser pointer in the computer-generated, 3D environment. As the user manipulates the computing device 750, the user in the AR space sees movement of the laser pointer. The user receives feedback from interactions with the computing device 750 in the AR environment on the computing device 750 or on the AR headset 790. The user's interactions with the computing device may be translated to interactions with a user interface generated in the AR environment for a controllable device.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer-implemented method, comprising:
capturing first image data, via an application executing on a computing device operated by a user, the first image data including a head of the user;
detecting at least one fixed feature in the first image data;
capturing second image data, the second image data including the head of the user;
detecting the at least one fixed feature in the second image data;
detecting a change in a position and an orientation of the computing device, from a first position and a first orientation corresponding to the capturing of the first image data, to a second position and a second orientation corresponding to the capturing of the second image data;
detecting a change in a position of the at least one fixed feature between the first image data and the second image data;
correlating the change in the position and the orientation of the computing device with the change in the position of the at least one fixed feature; and
determining a scale value applicable to the first image data and the second image data based on the correlating.

2. The computer-implemented method of claim 1, wherein the at least one fixed feature includes at least one facial feature.

3. The computer-implemented method of claim 2, wherein the at least one facial feature includes at least one of:
a distance between an outer corner portion of a right eye and an outer corner portion of a left eye of the user;
a distance between an inner corner portion of a right eye and an inner corner portion of a left eye of the user; or
a distance between a pupil of a right eye and a pupil of a right eye of the user.

4. The computer-implemented method of claim 1, wherein the at least one fixed feature includes a fixed element detected in a background area surrounding the head of the user.

5. The computer-implemented method of claim 1, wherein the at least one fixed feature includes a plurality of fixed features, including:
at least one facial landmark defined by two fixed facial features; and
at least one fixed element defined by at least two fixed key points detected in a background area surrounding the head of the user.

6. The computer-implemented method of claim 1, wherein detecting the change in the position and the orientation of the computing device includes:
detecting the first position and the first orientation of the computing device in response to receiving first data provided by an inertial measurement unit of the computing device at the capturing of the first image data;
detecting the second position and the second orientation of the computing device in response to receiving second data provided by the inertial measurement unit of the computing device at the capturing of the second image data; and
determining a magnitude of movement of the computing device corresponding to the change in the position and the orientation of the computing device based on a comparison of the second data to the first data.

7. The computer-implemented method of claim 6, wherein correlating the change in the position and the orientation of the computing device with the change in the position of the at least one fixed feature includes:
associating the magnitude of the movement of the computing device to the change in the position of the at least one fixed feature; and
assigning a scale value based on the associating.

8. The computer-implemented method of claim 1, wherein capturing the first image data and capturing the second image data includes:
initiating operation of a front facing camera of the computing device; and
capturing, by the front facing camera, the first image data and the second image data as the computing device is moved relative to the head of the user.

9. The computer-implemented method of claim 8, further comprising:
repeatedly capturing the first image data and the second image data as the computing device is moved relative to the user to capture image data from a plurality of different positions and orientations of the computing device relative to the head of the user;
correlating a plurality of changes in position and orientation of the computing device with a corresponding plurality of changes in position of the at least one fixed feature;
determining a plurality of estimated scale values based on the correlating; and
aggregating the plurality of estimated scale values to determine the scale value for sizing of a wearable device based on image data captured by the computing device.

10. The computer-implemented method of claim 1, wherein the capturing first image data and the capturing the second image data includes sequentially capturing a first image and a second image.

11. The computer-implemented method of claim 1, wherein the capturing the first image data and the capturing the second image data includes capturing additional image data between the capturing of the first image data and the second image data.

12. A non-transitory computer-readable medium storing executable instructions that when executed by at least one processor of a computing device are configured to cause the at least one processor to:
capture, by an image sensor of the computing device, first image data, the first image data including a head of a user;
detect at least one fixed feature in the first image data;
capture, by the image sensor, second image data, the second image data including the head of the user;
detect the at least one fixed feature in the second image data;
detect a change in a position and an orientation of the computing device, from a first position and a first orientation corresponding to the capture of the first image data, to a second position and a second orientation corresponding to the capture of the second image data;
detect a change in a position of the at least one fixed feature between the first image data and the second image data;
correlate the change in the position and the orientation of the computing device with the change in the position of the at least one fixed feature; and
determine a scale value applicable to the first image data and the second image data based on the correlation.

13. The non-transitory computer-readable medium of claim 12, wherein the at least one fixed feature includes at least one facial feature.

14. The non-transitory computer-readable medium of claim 13, wherein the at least one facial feature includes at least one of:
a distance between an outer corner portion of a right eye and an outer corner portion of a left eye of the user;
a distance between an inner corner portion of a right eye and an inner corner portion of a left eye of the user; or
a distance between a pupil of a right eye and a pupil of a right eye of the user.

15. The non-transitory computer-readable medium of claim 12, wherein the at least one fixed feature includes a fixed element detected in a background area surrounding the head of the user.

16. The non-transitory computer-readable medium of claim 12, wherein the at least one fixed feature includes a plurality of fixed features, including:
at least one facial landmark defined by two fixed facial features; and
at least one fixed element defined by at least two fixed key points detected in a background area surrounding the head of the user.

17. The non-transitory computer-readable medium of claim 12, wherein the instructions cause the at least one processor:
detect the first position and the first orientation of the computing device in response to receiving first data provided by an inertial measurement unit of the computing device at the capturing of the first image data;
detect the second position and the second orientation of the computing device in response to receiving second data provided by the inertial measurement unit of the computing device at the capturing of the second image data; and
determine a magnitude of movement of the computing device corresponding to the change in the position and the orientation of the computing device based on a comparison of the second data to the first data.

18. The non-transitory computer-readable medium of claim 17, wherein the instructions cause the at least one processor to:
associate the magnitude of the movement of the computing device to the change in the position of the at least one fixed feature; and
assign a scale value based on the association of the magnitude of the movement of the computing device with the change in the position of the at least one fixed feature.

19. The non-transitory computer-readable medium of claim 12, wherein the instructions cause the at least one processor to:
initiate operation of a front facing camera of the computing device; and
capture, by the front facing camera, the first image data and the second image data as the computing device is moved relative to the head of the user.

20. The non-transitory computer-readable medium of claim 19, wherein the instructions also cause the at least one processor to:
repeatedly capture the first image data and the second image data as the computing device is moved relative to the user to capture image data from a plurality of different positions and orientations of the computing device relative to the head of the user;
correlate a plurality of changes in position and orientation of the computing device with a corresponding plurality of changes in position of the at least one fixed feature;
determine a plurality of estimated scale values based on the correlating; and
aggregate the plurality of estimated scale values to determine the scale value for sizing of a wearable device based on image data captured by the computing device.

21. The non-transitory computer-readable medium of claim 12, wherein the instructions cause the at least one processor to at least one of:
capture the first image data and the second image data sequentially; or
capture additional image data between the capture of the first image data and the second image data.

22. A system, comprising:
a computing device, including:
an image sensor;
at least one processor; and
a memory storing instructions that, when executed by the at least one processor, cause the at least one processor to:
capturing first image data, the first image data including a head of a user;
detect at least one fixed feature in the first image data;
capture second image data, the second image data including the head of the user;
detect the at least one fixed feature in the second image data;
detect a change in a position and an orientation of the computing device, from a first position and a first orientation corresponding to the capturing of the first image data, to a second position and a second orientation corresponding to the capturing of the second image data;
detect a change in a position of the at least one fixed feature between the first image data and the second image data;
correlate the change in the position and the orientation of the computing device with the change in the position of the at least one fixed feature; and
determine a scale value applicable to the first image data and the second image data based on the correlating.

23. The system of claim 22, wherein the at least one fixed feature includes a plurality of fixed features, including:
at least one facial landmark defined by at least two fixed facial features; and
at least one fixed element defined by at least two fixed key points detected in a background area surrounding the head of the user.
